(19) United States
(12) Patent Application Publication
(10) Pub. No.: US 2013/0081888 A1
(43) Pub. Date: Apr. 4, 2013

(54) RECONFIGURABLE BASELINE OPENING FOR UNDER-HOOD AIRFLOW

(71) Applicants: Scott P. Charnesky, Birmingham, MI (US); Jason W. Guenzel, Milford, MI (US); Michael G. Leffert, Howell, MI (US); David J. Verbrugge, Milford, MI (US); Andreas Wilhelm, Seeheim-Jugenheim (DE)

(72) Inventors: Scott P. Charnesky, Birmingham, MI (US); Jason W. Guenzel, Milford, MI (US); Michael G. Leffert, Howell, MI (US); David J. Verbrugge, Milford, MI (US); Andreas Wilhelm, Seeheim-Jugenheim (DE)

(73) Assignee: GM GLOBAL TECHNOLOGY OPERATIONS LLC, Detroit, MI (US)

(21) Appl. No.: 13/249,672

(22) Filed: Sep. 30, 2011

(51) Int. Cl. B60K 13/02; B60K 11/06

(52) U.S. Cl. 180/68.3; 296/193.1

(57) ABSTRACT

A method of establishing a baseline airflow opening into an under-hood compartment of a vehicle configured to house a powertrain includes providing a fascia for the under-hood compartment. The fascia includes a first grille opening and a second grille opening configured to admit first and second portions of ambient airflow, respectively, into the under-hood compartment. A selectable position shutter assembly is disposed in the second grille opening and configured to control a size of the second grille opening. The baseline airflow opening into the under-hood compartment is the sum of the size of the first grille opening and the minimum size of the second grille opening. The method also includes ascertaining a configuration of the powertrain and setting the minimum size of the second grille opening in response to the ascertained configuration of the powertrain to establish the baseline airflow opening. A system employing the method is also disclosed.

### TECHNICAL FIELD

The invention relates to a system and a method of reconfiguring a minimum or baseline opening for airflow through an under-hood compartment of a motor vehicle.

### BACKGROUND

Among various other uses, motor vehicles frequently employ ambient airflow for cooling powertrain components situated in an under-hood compartment. Ambient airflow typically enters the under-hood compartment through a grille opening strategically positioned in a high pressure area on the vehicle body.

A baseline or minimum airflow admitted into the vehicle's under-hood compartment through the grille opening is generally determined in response to the minimum cooling requirements of the subject powertrain. In turn, the minimum cooling required by a specific powertrain is typically influenced by such factors as the aerodynamics, mass, intended use, and actual duty cycle of the subject vehicle, as well as the power output of the vehicle's engine. Accordingly, distinct powertrains may require significantly dissimilar levels of baseline airflow for effective cooling, even when such powertrains are configured as alternatives for the same vehicle line and the same under-hood compartment.

### SUMMARY

A method of establishing a baseline airflow opening into an under-hood compartment of a motor vehicle configured to house a powertrain includes providing a fascia for the under-hood compartment. The fascia includes a first grille opening and a second grille opening configured to admit a first portion and a second portion of an airflow, respectively, into the under-hood compartment from the ambient. The fascia includes a selectable position shutter assembly disposed in the second grille opening and configured to control a size of the second grille opening between a minimum and a maximum. The baseline airflow opening into the under-hood compartment is the sum of the size of the first grille opening and the minimum size of the second grille opening. The method also includes ascertaining a configuration, i.e., the design and arrangement of the powertrain, such as the size and power output of an engine. Additionally, the method includes setting the minimum size of the second grille opening via the shutter assembly in response to the ascertained configuration of the powertrain to establish the baseline airflow opening.

The shutter assembly may include a mechanism configured to select a position of the shutter assembly between and inclusive of fully opened and fully closed. According to the method, the position of the shutter assembly may be selected via the mechanism.

The position of the shutter assembly for the set minimum size of the second grille opening may be that of fully closed or partially opened.

The vehicle may include a controller configured to regulate the mechanism. According to the method, ascertaining the configuration of the powertrain and setting the minimum size of the second grille opening may be accomplished by the controller.

The method may also include monitoring the ambient temperature and selecting and locking a predetermined position for the shutter assembly via the controller in response to the ambient temperature being below a predetermined value.

The powertrain may include an internal combustion engine cooled by a circulating fluid, while the under-hood compartment may include a heat exchanger configured to cool the fluid via the airflow after the fluid cools the engine.

The engine may include a sensor configured to sense a temperature of the fluid. Accordingly, the method may additionally include regulating the mechanism by the controller to vary the size of the second grille opening between the set minimum and the maximum according to the sensed temperature.

The powertrain may either be slated to be installed into the under-hood compartment or be presently residing therein.

A system employing the above method and a vehicle employing such a system are also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view of a vehicle having a first, un-shuttered grille opening and a second, shuttered grille opening, each grille opening disposed at an entrance to an under-hood compartment;

FIG. 2 is a cross-sectional partial side view of the vehicle shown in FIG. 1, the second grille opening depicted in a partially opened state;

FIG. 3 is a cross-sectional partial side view of the vehicle shown in FIG. 1, the second opening depicted in a fully closed state; and

FIG. 4 is a flow chart illustrating a method of establishing the baseline airflow opening into the under-hood compartment of the vehicle depicted in FIGS. 1-3.

### DETAILED DESCRIPTION

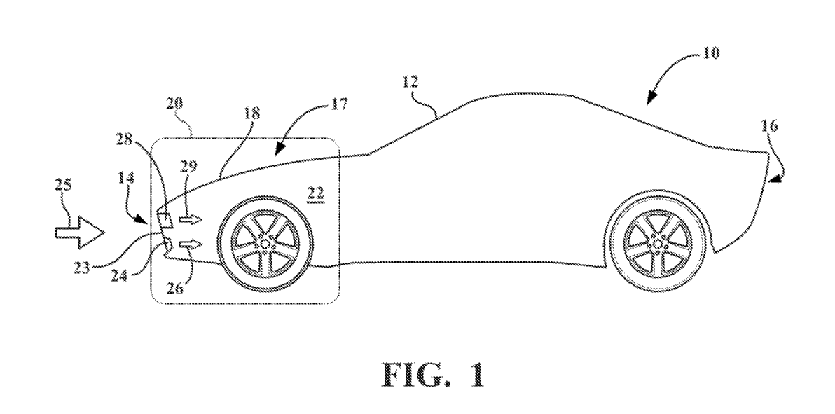

Referring to the drawings, wherein like reference numbers refer to like components, FIG. 1 shows a vehicle 10. The vehicle 10 includes a vehicle body 12 which is characterized by a first end 14 and a second end 16. The vehicle 10 also includes a hood 18 configured to cover a portion 20 of the first end 14 to thereby define an under-hood compartment 22. The vehicle 10 additionally includes a system 17 configured to establish a baseline airflow opening into the under-hood compartment 22. As will be described in greater detail below, the baseline airflow opening into the under-hood compartment 22 is reconfigurable or changeable via the system 17 in response to selectable alternative configurations of the vehicle 10.

As shown in FIGS. 1-3, the first end 14 of the vehicle body 12 includes a fascia 23 which is arranged at the entrance to the under-hood compartment 22. The fascia 23 is part of the system 17. The fascia 23 includes a first grille opening 24 and a second grille opening 28. The first grille opening 24 is configured to admit a first portion 26 of airflow 25 into the under-hood compartment 22 from the ambient. The second grille opening 28 is configured to admit a second portion 29 of the airflow 25 into the under-hood compartment 22 from the ambient. Furthermore, as will be described in detail later, the first and second grille openings 24, 28 of the fascia 23 together establish the baseline airflow opening into the under-hood compartment 22. Generally, openings that are located at the front of a vehicle, such as the first and second grille openings 24, 28, as well as various protruding features on the surface of the vehicle body tend to impact the vehicle's aerodynamic signature. Accordingly, it is typically beneficial to minimize the size of such openings whenever additional airflow into the under-hood compartment 22 is not required. Although two grille openings 24, 28 are depicted and described, nothing precludes the vehicle 10 from having a greater number of grille openings for admitting the airflow 25 into the under-hood compartment 22 from the ambient.

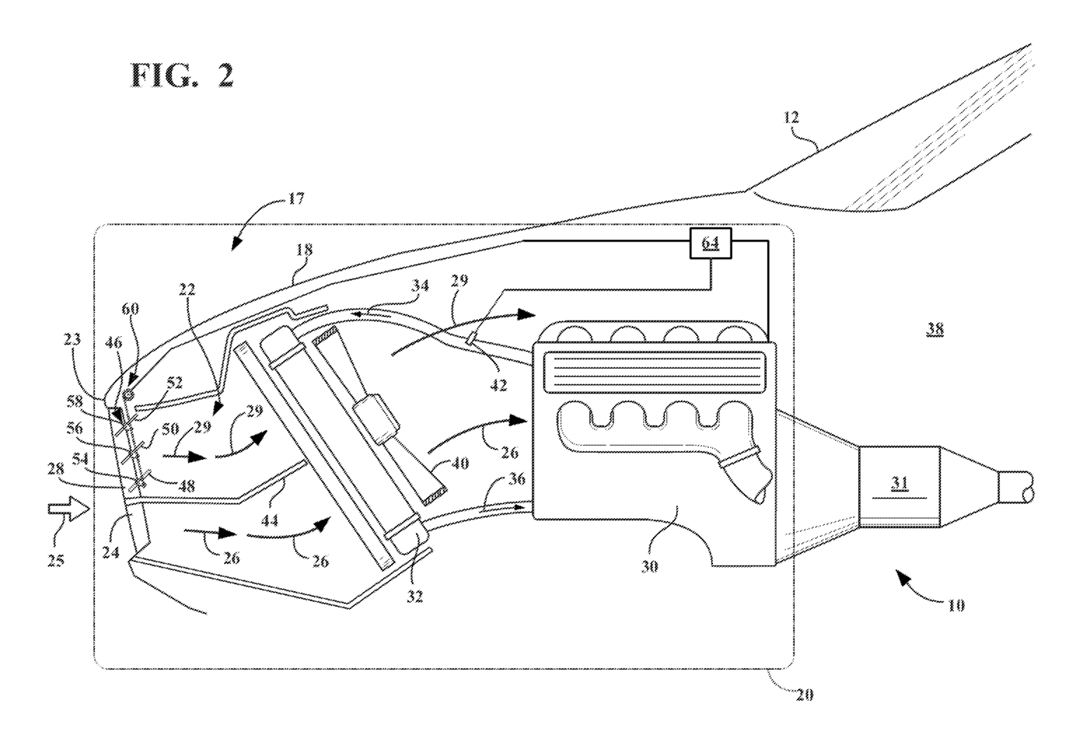

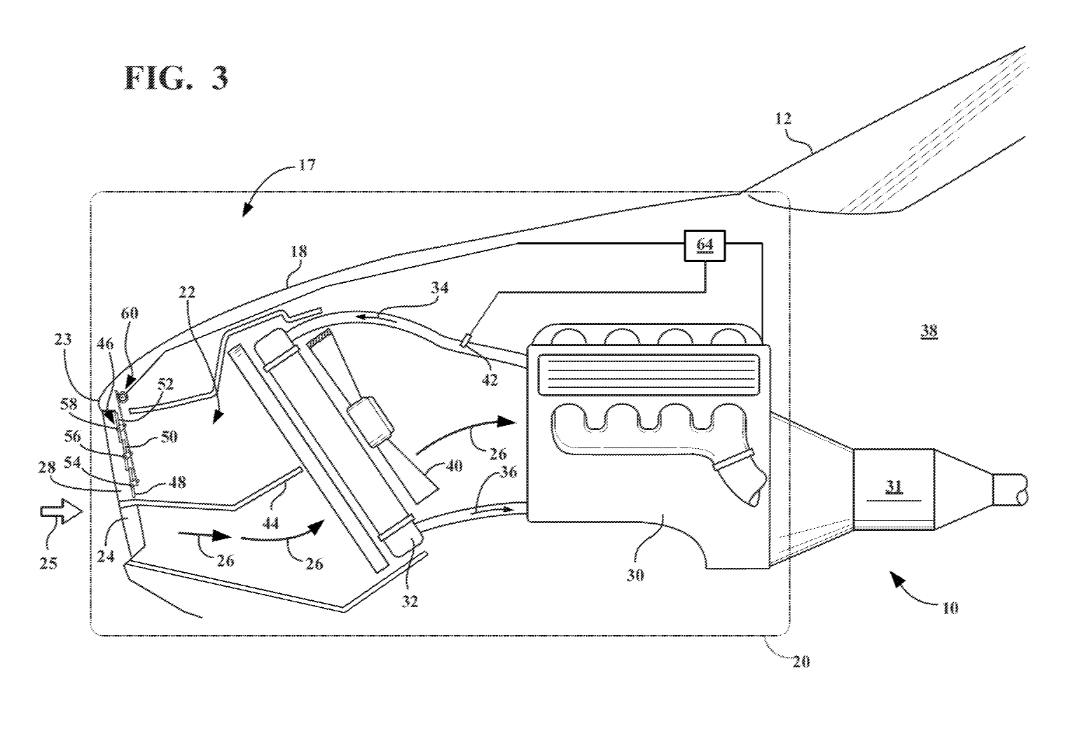

As shown in FIGS. 2-3, the vehicle 10 also includes an internal combustion engine 30 configured to propel the vehicle and an air-to-fluid heat exchanger 32, i.e., a radiator, for cooling the engine 30. The engine 30 is typically part of a vehicle powertrain that generally also includes a transmission 31, as shown. Although a single heat exchanger 32 is depicted, nothing precludes any number of heat exchangers being arranged side by side or in a series for cooling a number of vehicle systems or components, such as the transmission 31. Both the engine 30 and heat exchanger 32 are mounted in the under-hood compartment 22 where they can be accessed by one or both of the first and second airflow portions 26, 29. As shown, after being admitted through the grille opening 24, the first and second airflow portions 26, 29 are passed through the heat exchanger 32.

By passing through the heat exchanger 32, the first and second airflow portions 26, 29 facilitate cooling of a circulating fluid, such as water or a specially formulated coolant, shown by arrows 34 and 36, that is used to carry heat away from the engine 30 to the heat exchanger. Typically, the coolant is continuously circulated by a fluid pump (not shown) between the engine 30 and the heat exchanger 32. Accordingly, the arrow 34 represents the high-temperature coolant exiting the engine and the arrow 36 represents the reduced-temperature coolant exiting the heat exchanger. The transmission 31 is typically lubricated by oil that, in certain highly stressed vehicle applications, may require auxiliary cooling. In such applications, the transmission oil may also be passed through the heat exchanger 32 to achieve the desired cooling.

As shown in FIGS. 2-3, the heat exchanger 32 is positioned behind the first and second grille openings 24, 28 that are each covered by a mesh (not shown) for protection of the heat exchanger from various road- and air-borne debris. Although the heat exchanger 32 is shown as being positioned at the front of the vehicle 10, i.e., proximate to the first end 14, the heat exchanger may also be positioned in a different location, such as behind a passenger compartment 38. Positioning the heat exchanger 32 behind the passenger compartment 38 may be advantageous, if, for example, the vehicle has a rear or a mid-engine configuration. A fan 40 may be positioned behind the heat exchanger 32 for drawing the first and second airflow portions 26, 29 through the heat exchanger 32. The fan 40 may be driven either electrically by an electric motor (not shown) or mechanically by the engine 30. Accordingly, the fan 40 may be capable of being selectively turned on and off based on the cooling needs of the engine 30.

Depending on the road speed of the vehicle 10, the fan 40 is adapted to either generate or enhance the airflow 25 from the ambient through the first and second grille openings 24, 28 and on through the heat exchanger 32. Thus generated or enhanced through the action of the fan 40, the first and second airflow portions 26, 29 are passed through the heat exchanger 32 to remove heat from the high-temperature coolant 34 before the reduced-temperature coolant 36 is returned to the engine 30. The vehicle 10 additionally includes a coolant sensor 42 configured to sense a temperature of the high-temperature coolant 34 as the coolant exits the engine 30. Accordingly, the first and second portions 26, 29 of the airflow 25 are employed for cooling the engine 30, as well as other various components housed within the under-hood compartment 22.

As shown in FIGS. 2-3, after the first and second airflow portions 26, 29 enter the under-hood compartment 22 through the first and second grille openings 24, 28, the first and second airflow portions may be maintained as separate flows by a partition 44. Each of the first and second airflow portions 26, 29 is passed through the heat exchanger 32. Additionally, the partition 44 may be configured to extend past the fan 40 to maintain the first airflow portion 26 separate from the second airflow portion 29 after the respective airflow portions have passed through the heat exchanger 32.

FIGS. 2-3 also depict a rotatable or selectable position shutter assembly 46. The shutter assembly 46 is disposed in the second grille opening 28 and is adapted to regulate the second airflow portion 29 entering the under-hood compartment 22. Although a single shutter assembly 46 is depicted and described as being disposed within the second grille opening 28, nothing precludes a separate, similar shutter assembly from being disposed in another grille opening for regulating the airflow 25 if the vehicle 10 employs more than two grille openings. As shown, the shutter assembly 46 includes a plurality of louvers, herein shown as having three individual louver elements 48, 50, and 52, but the number of louvers may be either fewer or greater. The shutter assembly 46 is configured to control the second grille opening 28 between a minimum and a maximum size, such that a flow rate of the second airflow portion 29 entering the under-hood compartment 22 is adjusted or varied. Each louver element 48, 50, and 52 is configured to rotate about a respective pivot axis 54, 56, and 58 during operation of the shutter assembly 46. Such rotation of the louvers 48, 50, and 52 effectively controls the size of the second grille opening 28 and the amount and flow rate of the second airflow portion 29 entering the under-hood compartment 22. The shutter assembly 46 permits the system 17 to establish the baseline airflow opening into the under-hood compartment 22 by controlling the size of the second grille opening 28 and combining thus varied second airflow portion 29 with the fixed first airflow portion 26.

The shutter assembly 46 is adapted to operate between and inclusive of a fully closed position or state, through an intermediate or partially opened position, and to a fully opened position. Accordingly, when the louver elements 48, 50, and 52 are in the fully opened position, which is not shown but would be appreciated by those skilled in the art, the second airflow portion 29 is unrestricted to enter the under-hood compartment 22. Additionally, when the louver elements 48, 50, and 52 are in the partially opened position (as shown in FIG. 2) the second airflow portion 29 may enter the under-hood compartment 22, but its passage through the second grille opening 28 is restricted. Furthermore, when the louver elements 48, 50, and 52 are in the fully closed position (as shown in FIG. 3), the second airflow portion 29 is substantially blocked from entering the under-hood compartment 22.

The shutter assembly 46 also includes a mechanism 60 configured to adjust the louver elements 48, 50, and 52, which thereby selects and locks a desired position of the shutter assembly between and inclusive of fully opened and fully closed. The mechanism 60 is configured to cause the louvers 48-52 to rotate in tandem, i.e., substantially in unison, and permitting the shutter assembly 46 to adopt any of the available positions. The mechanism 60 may be adapted to select discrete intermediate position(s) of the louvers 48-52, or to infinitely vary the position of the louvers between and inclusive of the fully opened and fully closed. The mechanism 60 acts to select the desired position for the shutter assembly 46 when the mechanism is activated by any external means, such as an electric motor (not shown). Accordingly, the minimum base airflow into the under-hood compartment 22 is the sum of the first airflow portion 26 provided through the continuously exposed first grille opening 24 and the second airflow portion 29 controlled via the shutter assembly 46.

The system 17 also includes a controller 64 (shown in FIGS. 2-3), which may be an engine controller or a separate control unit, configured to operate the mechanism 60 for selecting the desired position of the shutter assembly 46. The controller 64 may also be configured to operate the fan 40, if the fan is electrically driven, and a thermostat (not shown) that is configured to regulate the circulation of coolant, as understood by those skilled in the art. The controller 64 is programmed to operate the mechanism 60 in response to variation in load or stress on the engine 30 and according to the temperature of the coolant sensed by the sensor 42. The controller 64 is also configured to ascertain a configuration of the powertrain including its respective engine 30 that is either slated to be, i.e., configured and scheduled for installation, or is already arranged in the under-hood compartment 22. The term “configuration of the powertrain” as employed herein includes such factors as the physical design of the engine 30, for example the number of cylinders and their arrangement, the engine's size, and its power output.

The controller 64 is additionally configured to set the minimum size of the second grille opening 28 via the shutter assembly 46 in response to the ascertained configuration of the powertrain to establish the baseline airflow opening into the under-hood compartment 22. In establishing the baseline airflow opening for a specific powertrain by the controller 64 via setting the minimum size of the second grille opening 28, the selected and set position of the shutter assembly 46 may be that of fully closed or partially opened. The fully opened position of the shutter assembly 46 is accordingly reserved to generate maximum airflow into the under-hood compartment 22 during high load operation of any of the alternative powertrains and their respective engines 30.

The temperature of the high-temperature coolant 34 is increased due to the heat produced by the engine 30 under load. As known by those skilled in the art, having the engine 30 propel the vehicle 10 up a hill and/or pull a trailer are the types of increased stress operating conditions that drive up the internal temperature of the engine. In turn, an increase in the engine's internal temperature necessitates more rapid engine cooling for desired performance and reliability. Cooling requirements of a powertrain that may be installed into the under-hood compartment 22 typically necessitate a predetermined baseline or minimum amount of airflow 25 to be admitted into the vehicle's under-hood compartment. The required amount of baseline airflow 25 is primarily influenced by the amount of heat generated by the engine 30 while powering the vehicle 10 and which must be removed to ensure reliable engine operation. The required amount of baseline airflow 25 is also influenced by such factors as the aerodynamic profile, mass, and intended use of the subject vehicle. Consequently, the ratio of engine power to the mass of the vehicle 10 affects the overall amount of heat that is developed by the engine 30, especially during extended vehicle maneuvers, such as pulling a load and/or ascending a grade.

As noted above, the under-hood compartment 22 of the vehicle 10 may be configured to accept a number of alternative distinct powertrains. A specific powertrain may be selected based on the intended use of the vehicle 10 or the general preference of the vehicle's user. Accordingly, during the initial design of the vehicle 10, the under-hood compartment 22 is typically configured to accommodate each of the alternative powertrains. Hence, although the physical size of the alternative powertrains, as well as the power output of the respective engines, may be vastly different, the overall size and layout of the particular under-hood compartment 22 remains relatively unchanged.

For example, during low load base engine operation, an alternative smaller engine 30 may generate a first amount of heat, while an alternative larger engine 30 may generate a second, higher amount of heat during similar low load base engine operation. Consequently, for effective cooling of each alternative powertrain a significantly different level of the baseline airflow 25 may be required into the under-hood compartment 22. Accordingly, typical vehicle construction may require either a separate fascia 23 or an additional component, such as a grille blocker, to be employed for each alternative powertrain installed in the under-hood compartment 22.

In order for the vehicle 10 to offer the option of alternative powertrains without having to use a different fascia 23 or an additional component with each such powertrain, the system 17 sets the minimum size of the second grille opening 28 to establish an appropriate baseline airflow opening. As noted above, the system 17 establishes a baseline airflow opening into the under-hood compartment 22 by varying the size of the second grille opening 28 via the shutter assembly 46 in response to the specific configuration of the powertrain. Overall, because the effective baseline airflow opening into the under-hood compartment 22 is the sum of the size of the first grille opening 24 and the minimum size of the second grille opening 28, the baseline airflow is the sum of the first airflow portion 26 and the controlled second airflow portion 29. As such, sufficient baseline airflow is admitted into the under-hood compartment 22 based on the cooling requirements of a particular powertrain and its respective engine 30 by varying the size of the second grille opening 28 via the shutter assembly 46.

When the fully closed position (shown in FIG. 3) for the shutter assembly 46 is selected by the controller 64, the base airflow to the under-hood compartment 22 is set up solely through the first grille opening 24. Accordingly, the fully closed position for the shutter assembly 46 sets up the minimum baseline airflow opening and achieves the absolute minimum level of cooling for the high-temperature coolant 34 inside the heat exchanger 32. An intermediate, partially opened position (shown in FIG. 2) for the shutter assembly 46 may also be selected and set by the controller 64. Such a partially opened position for the shutter assembly 46 serves to generate a commensurate intermediate flow rate of the second airflow portion 29 into the under-hood compartment 22. Consequently, a partially opened position of the shutter assembly 46 together with the fixed first grille opening 24 establishes an increased effective baseline airflow opening sufficient to address increased cooling needs of a larger and more powerful alternative engine 30.

When the fully opened position for the shutter assembly 46 is selected by the controller 64, the level of cooling for the high-temperature coolant 34 is at an absolute maximum. The fully opened position of the shutter assembly 46 combines the maximum second airflow portion 29 with the first airflow portion 26 to provide sufficient cooling to the engine 30 when an increased amount of heat is generated by the engine during high stress operation. Accordingly, the fully opened position for the shutter assembly 46 achieves an increased level of cooling for the high-temperature coolant 34 inside the heat exchanger 32, as may be required by the cooling needs of any of the alternative engines at higher operating loads.

Ambient temperatures near and below freezing may present additional considerations for cooling of the powertrain in the vehicle 10. When the ambient temperature is below a predetermined value, i.e., near or below freezing, sufficient cooling of engine 30 may be achieved with the second grille opening 28 either in a partially restricted or in a fully blocked state. At the same time, louvers 48-52 and mechanism 60 may freeze and become jammed at such low temperatures. Therefore, in order to prevent jamming of the shutter assembly 46 in some unwanted position, when the ambient temperature is below the predetermined value, an appropriate predetermined position of the shutter assembly may be selected and locked without regard to vehicle speed and load. The second grille opening 28 may be placed in any position between and inclusive of the fully open and the fully restricted states via the predetermined position of the shutter assembly 46 depending on the cooling requirements of the powertrain of vehicle 10.

The predetermined locked position or a number of discrete locked positions of the shutter assembly 46 that would still permit sufficient cooling of the powertrain near and below freezing ambient temperatures may be established empirically during testing and development of the vehicle 10. The controller 64 may be employed to monitor the ambient temperature via a temperature sensor (not shown) and regulate and lock the position of the shutter assembly 46 via the mechanism 60 in response to the ambient temperature being below the predetermined value. Depending on the vehicle load, the fan 40 may be either turned on or off via the controller 64 while the shutter assembly 46 remains in the predetermined locked position. Full control over the selectable positions of shutter assembly 46 may then be returned when the ambient temperature again rises above the predetermined value.

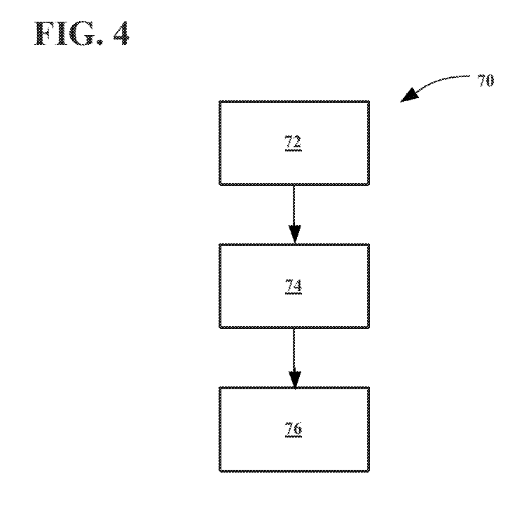

FIG. 4 depicts a method 70 of establishing the baseline airflow opening into the under-hood compartment 22 through the first and second grille openings 24, 28. As described with respect to FIGS. 1-3 above, the under-hood compartment 22 of the vehicle 10 is configured to house various configurations of the powertrain having a specific engine 30 and/or transmission 31. The method commences in frame 72 where it includes providing a fascia 23 for the under-hood compartment 22. The fascia 23 having the first and second grille openings 24, 28 may be provided for the vehicle 10 either during the original assembly of the vehicle or at a service facility, for example during vehicle repair.

Following frame 72, the method advances to frame 74. In frame 74, the method includes ascertaining via the controller 64 a configuration of the powertrain that is intended for the under-hood compartment 22. Depending on whether the vehicle 10 is being assembled in a manufacturing facility, or is being retrofitted at a service facility, the particular powertrain may either be slated to be installed into the under-hood compartment 22 or be already arranged therein. After the configuration of the powertrain has been ascertained in frame 74, the method advances to frame 76.

In frame 76 the method includes setting the minimum size of the second grille opening 28 with the controller 64 regulating the shutter assembly 46 in response to the ascertained configuration of the powertrain to establish the baseline airflow opening. As discussed above with respect to FIGS. 1-3, the amount of the second airflow portion 29 admitted through the second grille opening 28 is additive to the amount of the first airflow portion 26 admitted through the first grille opening 24. Accordingly, the fixed size of the first grille opening 24 and the selected and set size of the second grille opening 28 together define the effective baseline airflow opening into the under-hood compartment 22.

While the best modes for carrying out the invention have been described in detail, those familiar with the art to which this invention relates will recognize various alternative designs and embodiments for practicing the invention within the scope of the appended claims.

1. A method of establishing a baseline airflow opening into an under-hood compartment of a motor vehicle configured to house a powertrain, the method comprising:
providing a fascia for the under-hood compartment, wherein the fascia includes:
a first grille opening and a second grille opening configured to admit a first portion and a second portion of an airflow, respectively, into the under-hood compartment from the ambient; and
a selectable position shutter assembly disposed in the second grille opening and configured to control a size of the second grille opening between a minimum and a maximum, wherein the baseline airflow opening into the under-hood compartment is the sum of the size of the first grille opening and the minimum size of the second grille opening;
ascertaining a configuration of the powertrain; and
setting the minimum size of the second grille opening via the shutter assembly in response to the ascertained configuration of the powertrain to establish the baseline airflow opening.

2. The method of claim 1, wherein the shutter assembly includes a mechanism configured to select a position of the shutter assembly between and inclusive of fully opened and fully closed, the method further comprising selecting the position of the shutter assembly via a mechanism.

3. The method of claim 2, wherein the position of the shutter assembly for the set minimum size of the second grille opening is that of fully closed.

4. The method of claim 2 wherein the position of the shutter assembly for the set minimum size of the second grille opening is that of partially opened.

5. The method of claim 2, wherein the vehicle includes a controller configured to regulate the mechanism, and wherein each of said ascertaining the configuration of the powertrain and setting the minimum size of the second grille opening is accomplished by the controller.

6. The method of claim 5, further comprising monitoring the ambient temperature and selecting and locking a predetermined position for the shutter assembly via the controller in response to the ambient temperature being below a predetermined value.

7. The method of claim 5, wherein the powertrain includes an internal combustion engine cooled by a circulating fluid and the under-hood compartment includes a heat exchanger configured to cool the fluid via the airflow after the fluid cools the engine.

8. The method of claim 7, wherein the engine includes a sensor configured to sense a temperature of the fluid, the method further comprising regulating the mechanism by the controller to vary the size of the second grille opening between the set minimum and the maximum according to the sensed temperature.

9. The method of claim 1, wherein the powertrain is one of slated to be installed and presently residing in the under-hood compartment.

10. A system for reconfiguring a baseline airflow opening into an under-hood compartment of a motor vehicle configured to house a powertrain, the system comprising:
a fascia for the under-hood compartment, wherein the fascia includes:
a first grille opening and a second grille opening configured to admit a first portion and a second portion of an airflow, respectively, into the under-hood compartment from the ambient; and
a selectable position shutter assembly disposed in the second grille opening and configured to control a size of the second grille opening between a minimum and a maximum, wherein the baseline airflow opening into the under-hood compartment is the sum of the size of the first grille opening and a minimum size of the second grille opening; and
a controller arranged on the vehicle and configured to:
ascertain a configuration of the powertrain; and
set the minimum size of the second grille opening via the shutter assembly in response to the ascertained configuration of the powertrain to establish the baseline airflow opening.

11. The system of claim 10, wherein the shutter assembly includes a mechanism regulated by the controller and configured to select a position of the shutter assembly between and inclusive of fully opened and fully closed.

12. The system of claim 11, wherein the position of the shutter assembly for the set minimum size of the second grille opening is that of fully closed.

13. The system of claim 11, wherein the position of the shutter assembly for the set minimum size of the second grille opening is that of partially opened.

14. The system of claim 10, wherein the controller is additionally configured to monitor the ambient temperature and select and lock a predetermined position for the shutter assembly in response to the ambient temperature being below a predetermined value.

15. The system of claim 10, wherein the powertrain includes an internal combustion engine cooled by a circulating fluid and the under-hood compartment includes a heat exchanger configured to cool the fluid via the airflow after the fluid cools the engine.

16. The system of claim 15, wherein the engine includes a sensor configured to sense a temperature of the fluid, and the controller is configured to regulate the mechanism to vary the size of the second grille opening between the set minimum and the maximum according to the sensed temperature.

17. The system of claim 10, wherein the powertrain is one of slated to be installed and presently residing in the under-hood compartment.

18. A vehicle comprising:
a powertrain including an internal combustion engine cooled by a circulating fluid;
a heat exchanger configured to cool the fluid via an ambient airflow after the fluid cools the engine;
an under-hood compartment housing the powertrain and the heat exchanger;
a fascia for the under-hood compartment, wherein the fascia includes:
a first grille opening and a second grille opening configured to admit a first portion and a second portion of the ambient airflow, respectively, into the under-hood compartment; and
a selectable position shutter assembly disposed in the second grille opening and configured to control a size of the second grille opening between a minimum and a maximum, wherein a baseline airflow opening into the under-hood compartment is the sum of the size of the first grille opening and a minimum size of the second grille opening;
a mechanism configured to select a position of the shutter assembly between and inclusive of fully opened and fully closed; and
a controller arranged on the vehicle and configured to:
ascertain a configuration of the powertrain; and
set the minimum size of the second grille opening via the shutter assembly via the mechanism in response to the ascertained configuration of the powertrain to establish the baseline airflow opening;
wherein the mechanism is regulated by the controller.

19. The vehicle of claim 18, wherein the position of the shutter assembly for the set minimum size of the second grille opening is one of fully closed and partially opened.

20. The vehicle of claim 18, wherein the engine includes a sensor configured to sense a temperature of the fluid, and the controller is configured to regulate the mechanism to vary the size of the second grille opening between the set minimum and the maximum according to the sensed temperature.
